(19) United States
(12) Patent Application Publication
(10) Pub. No.: US 2006/0231980 A1
(43) Pub. Date: Oct. 19, 2006

(54) Method for producing ceramic green compact and apparatus for producing the same

(75) Inventors: Teppei Kubota, Kusatsu-shi (JP); Naokatsu Fujinami, Higashioumi-shi (JP)

Correspondence Address: OSTROLENK FABER GERB & SOFFEN, 1180 AVENUE OF THE AMERICAS, NEW YORK, NY, 100368403, US

(73) Assignee: Murata Manufacturing Co., Ltd.

(21) Appl. No.: 11/201,965

(22) Filed: Aug. 10, 2005

(30) Foreign Application Priority Data
Apr. 18, 2005 (JP) 2005-119165

(51) Int. Cl. B28B 3/02; B29C 41/42; B29C 43/02

(52) U.S. Cl. 264/319; 264/334

(57) ABSTRACT

A separable die including a plurality of molding through holes is disposed in a recess in a cavity of a molding die. Slurry containing a ceramic powder and a solvent is supplied in the cavity. The slurry in the cavity is then pressed into the molding holes of the separable die by pressure due to a movement of a punch. Excess solvent is removed by suction by a stage for suction dewatering provided at the rear of the separable die thereby forming green compacts in the molding holes. Subsequently, the separable die is removed from the molding die. The green compacts are released from the molding holes of the separable die in a separate state.

### BACKGROUND OF THE INVENTION

1. Field of the Invention

The present invention relates to a method for producing a ceramic green compact, and in particular, to a method for producing a ceramic green compact by a wet pressing process.

2. Description of the Related Art

In the production of ceramic electronic components such as a chip inductor, a method is employed in which a ceramic green compact is prepared and the ceramic green compact is then sintered to produce a ceramic sintered compact. Examples of the method for making a ceramic green compact include powder pressing and wet pressing. In the wet pressing process, ceramic slurry containing a ceramic powder and a solvent is charged in a die, the slurry is uniaxially pressurized with a punch, and the excessive solvent in the slurry is removed from a part facing the punch by suction to obtain a green compact. This process is advantageous in that a green compact having less pores and higher density can be produced than with powder pressing.

Japanese Unexamined Patent Application Publication No. 9-29717 discloses a method of wet pressing for a ceramic green compact. In the method, a green compact having a high density and a smooth surface is produced by controlling the pressurizing time or the moving distance of a punch from the time when the excessive solvent is discharged from all the slurry in a die to form a green compact to the time when the pressurizing is stopped.

FIG. 7 shows an apparatus for wet pressing disclosed in Japanese Unexamined Patent Application Publication No. 9-29717.

A punch 22 is inserted in a tubular molding die 21. Slurry S is charged in a cavity 23 formed by the molding die 21 and the punch 22. A paper filter 24 is disposed on the surface of the molding die 21, the surface facing the punch 22. A die 25 for suction dewatering is disposed on the filter 24. A porous member 26 facing the filter 24 is disposed in the die 25 for suction dewatering. A plurality of dewatering holes 27 are provided at the rear of the porous member 26. When the slurry S is pressurized with the punch 22, a solvent in the slurry S is simultaneously removed from the dewatering holes 27 by suction. Thus, a green compact is formed in the cavity 23 of the molding die 21.

In this method, as in normal methods of wet pressing, the punch 22 and the die 25 for suction dewatering, i.e., the die 25 used for discharging the solvent, are provided in a one-to-one relationship. In other words, the punch 22 and the die 25 for suction dewatering are arranged so as to pressurize in the uniaxial direction. Therefore, only one green compact is formed by a single molding. Accordingly, the number of processed products is small and a sufficient production capacity cannot be achieved. To solve this problem, a large green compact may be molded and then sintered. After the sintering, the sintered compact may be divided into small pieces by cutting. However, such a method disadvantageously causes a loss of material and increases the number of steps, thereby increasing the cost.

Furthermore, it is difficult to release the green compact from the die 21. In addition, the density of the green compact is easily varied.

### SUMMARY OF THE INVENTION

Accordingly, it is an object of the present invention to provide a method for producing a ceramic green compact by a wet pressing process, wherein a plurality of green compacts can be simultaneously produced by a single molding and the green compacts can be easily released from a die, and to provide an apparatus for producing the same.

In order to achieve the above object, a first aspect of the present invention provides a method for producing a ceramic green compact including the steps of disposing a separable die including a plurality of molding through holes in a cavity of a molding die; supplying the cavity of the molding die with slurry containing a ceramic powder and a solvent; forming green compacts in the molding holes by pressurizing the slurry in the cavity by moving a punch provided in the molding die so as to press the slurry into the molding holes of the separable die, while the solvent is removed to the rear of the separable die; removing the separable die from the molding die; and releasing the green compacts from the molding holes of the separable die in a separate state.

A second aspect of the present invention provides an apparatus for producing a ceramic green compact including a molding die including a cavity in which slurry containing a ceramic powder and a solvent is supplied; a separable die disposed in the cavity so as to be separated from the molding die, the separable die including a plurality of molding through holes; a punch that pressurizes the slurry in the cavity so as to press the slurry into the molding holes of the separable die, thereby forming green compacts in the molding holes; and a unit for removing the excessive solvent in the slurry passed through the molding holes, the unit being provided at a position facing the punch.

In the method according to the present invention, a separable die including a plurality of molding through holes is disposed in a molding die. Slurry is pressed into the molding holes by pressurizing a punch, and in addition, the excessive solvent is removed from the rear of the separable die. Thus, green compacts can be molded in the molding holes in a substantially separate state. After the molding, the separable die is removed from the molding die. Since the molding holes are through holes, the green compacts can be easily released from the molding holes of the separable die.

Thus, each of the green compacts is molded in the plurality of the molding holes of the separable die in a substantially separate state. Therefore, a plurality of green compacts can be molded in a single shot, and in addition, the green compacts can be easily released from the die.

When green compacts have substantially the shape of the final product, the sintered compacts need not be cut to separate them from each other and cutting operations such as a circumference processing and a slicing processing can be omitted. Accordingly, the man-hours for processing can be reduced, and the production cost can also be reduced.

When a large green compact is molded and the compact is then divided into small pieces, the density of the small green compacts is often varied depending on the site of the small green compact within the original large green compact. In contrast, in the present invention, since all the small green compacts are formed in the molding process, the variation in the compact density can be reduced. As a result, green compacts having even quality can be produced.

The arrangement of the molding holes is not particularly limited. Arrangements such as a square arrangement, a zigzag arrangement, and a concentric arrangement may be used. The molding holes may have any shape. Green compacts having a high aspect ratio can also be formed according to the relationship between the open area of the holes and the thickness of the separable die.

The separable die may be a continuous plate type, segmental die type, a blade (partition plate) type, or the like, but is not limited to these.

According to a preferred embodiment, in the step of forming green compacts in the molding holes, a molding end point is preferably set such that the movement of the punch is completed before the punch is in contact with the separable die, and the green compacts formed in the molding holes are preferably connected to each other, with a connecting part therebetween having a small thickness and being formed on a surface of the separable die, the surface being adjacent to the punch. In addition, the connecting part is preferably removed in the step of removing the green compacts from the molding holes of the separable die in a separate state.

When the punch can move to the position where the punch is in contact with the separable die, an excessive pressure may be applied on the separable die during the pressurizing, thereby decreasing the pressure applied on the green compacts. In contrast, when the molding end point is set such that the movement of the punch is completed before the punch is in contact with the separable die, the excessive pressure is not applied on the separable die. As a result, a sufficient pressure can be applied to the green compacts, and in addition, the in-plane pressure applied on the entire separable die can be substantially uniform. In such a case, green compacts formed in the molding holes are connected to each other with a connecting part therebetween having a small thickness. When the green compacts are released from the molding holes of the separable die, the connecting part can be removed. Thus, each of the green compacts can be released in a separate state.

The thickness of the connecting part is preferably smaller than the thickness of the green compact. The connecting part is preferably a thin wall part having a thickness of 1 mm or less. In this case, the connecting part can be easily removed.

According to another preferred embodiment, the separable die is preferably composed of a flat mold plate, and the molding holes are preferably formed so as to be open at both principal surfaces of the mold plate.

In this case, since the depths of the molding holes are the same, the thickness of the green compacts is not varied. Furthermore, the green compacts in the molding holes can be readily released by pressing the green compacts in a direction from a principal surface of the separable die.

According to another embodiment, a recess extending from the cavity is preferably provided on a surface of the molding die, namely the surface disposed at the side where the solvent is removed, and the periphery of the separable die is preferably positioned in the recess.

In this case, the position of the separable die relative to the molding die can be stabilized by the recess. As a result, the separable die is not misaligned and molding is accurate.

Furthermore, according to another embodiment, the separable die may be composed of a plurality of flat mold plates disposed in a series in the direction parallel to both principal surfaces of the mold plates.

In such a case, when the separable die is composed of a plurality of mold plates having a plate shape, the green compacts can be released more easily.

The inner surfaces of the molding holes of the separable die may be tapered surfaces each having a slope in the thickness direction of the separable die. The tapered shape may be formed either in the forward direction or the opposite direction relative to the direction of the movement of the punch. Also in this case, the green compact can be more easily released from the separable die. In such a case, an oleophilic die lubricant may be applied on the inner surfaces of the molding holes to further improve the mold releasability.

As described above, according to the present invention, a separable die having a plurality of molding holes is disposed in a molding die so that green compacts are formed in each molding hole. Accordingly, the green compacts are formed in the plurality of molding holes of the separable die in a substantially separate state. Therefore, a plurality of small green compacts can be produced at the same time to improve the production capacity.

In addition, green compacts that substantially have a net shape and a net dimension of the final product can be directly produced. Therefore, a cutting operation can be omitted, and a loss of material can be decreased. Thus, the production cost of ceramic components can be reduced.

After the molding, the separable die can be removed from the molding die. Therefore, green compacts can be easily released from the molding holes of the separable die, thus facilitating the removal of the green compacts. This structure allows even a green compact such as a bar having a large aspect ratio to be readily molded.

Furthermore, according to the present invention, the small green compacts are formed in the same molding process. Consequently, the variation in the density between green compacts can be decreased to produce green compacts having even quality.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view showing an apparatus for wet pressing according to a first embodiment of the present invention;

FIG. 2 is a perspective view of a separable die plate used in the apparatus for wet pressing in FIG. 1;

FIGS. 3A, 3B and 3C are process drawings showing the first half of a molding process in the present invention;

FIGS. 4A and 4B are process drawings showing the latter half of the molding process in the present invention;

FIG. 5 is a perspective view of a separable die plate according to a second embodiment of the present invention;

FIG. 6 is a perspective view of a separable die plate according to a third embodiment of the present invention; and

FIG. 7 is a cross-sectional view of a known apparatus for wet pressing.

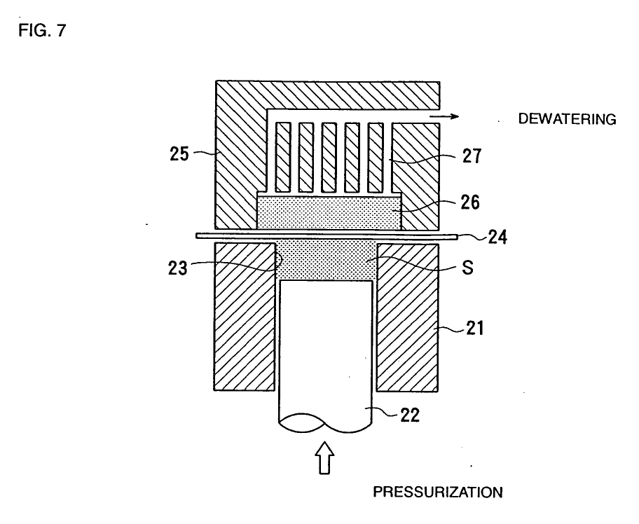

### DESCRIPTION OF PREFERRED EMBODIMENTS OF THE INVENTION

Three embodiments of the present invention will now be described in detail with reference to an Example.

### FIRST EMBODIMENT

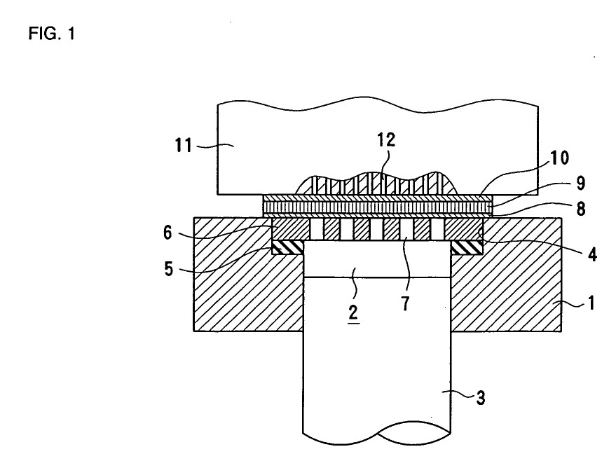

FIG. 1 shows an apparatus for wet pressing according to a first embodiment of the present invention.

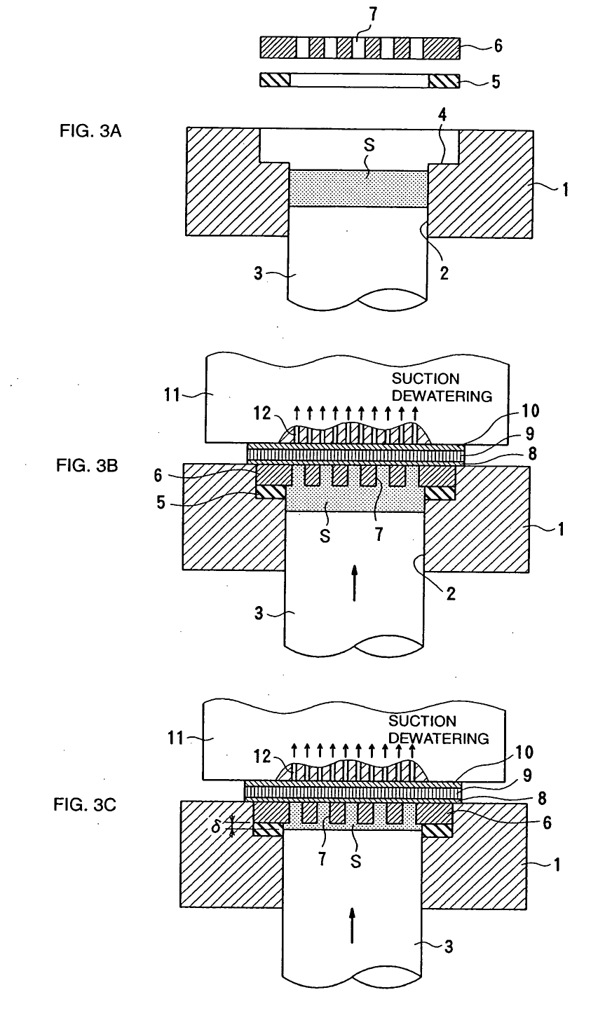

A molding apparatus of this embodiment includes a die (molding die) 1. A cavity 2 is provided in the die 1 so as to penetrate the die 1. A punch 3 is inserted from the lower part of the cavity 2. The punch 3 is uniaxially moved in the vertical direction by a driving unit not shown in the figure. Ceramic slurry S (FIGS. 3A-3C) containing a ceramic powder and a solvent is supplied to the cavity 2. A recess 4 that is larger than the cavity 2 is provided on the upper surface of the die 1, that is, the upper end opening of the cavity 2. A separable die plate 6, which is an example of a separable die, is fitted in the recess 4, with a rubber packing 5 therebetween. Since the periphery of the separable die plate 6 is positioned by the inner periphery of the recess 4, inclination or displacement in the planar direction can be prevented.

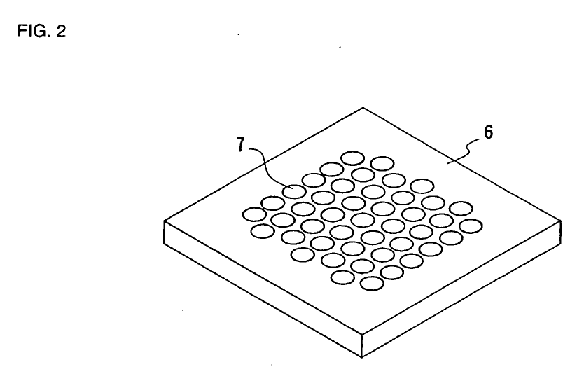

As shown in FIG. 2, the separable die plate 6 is composed of a flat plate and includes a plurality of molding holes 7 penetrating in the direction perpendicular to the upper and lower principal surfaces (in the thickness direction). The outer shape of the separable die plate 6 and the shape of the molding holes 7 are not particularly limited. In this embodiment, the separable die plate 6 has a quadrangle shape and the molding holes 7 are round holes having the same diameter. The molding holes 7 are collectively arrayed at the center of the separable die plate 6 so that the molding holes 7 are disposed within the area of the cavity 2. The separable die plate 6 is preferably composed of a metal having high strength and rigidity such as a steel, e.g., a precipitation hardening steel or a stainless steel (SUS), or an aluminum base alloy.

In the above embodiment, the molding holes 7 provided in the separable die plate 6 may be tapered holes each having a slope in the thickness direction of the separable die plate 6.

A filter paper 8, a filter cloth 9, and wire gauze 10 are disposed on the separable die plate 6, in that order. A stage 11 for suction dewatering is pressed downward from the upper face. By the pressing, the filter paper 8, the filter cloth 9, the wire gauze 10, and the separable die plate 6 are closely contacted with each other, and in addition, the separable die plate 6 is also closely contacted with the rubber packing 5. The filter paper 8, the filter cloth 9, and the wire gauze 10 are used for removing the excessive solvent in the ceramic slurry S by suction filtration. The combination of these components is not limited to the above so long as the solvent can be removed by suction filtration. For example, a porous member may be disposed on the filter paper 8 and the solvent may be sucked out by the stage 11 for suction dewatering, the stage 11 being disposed on the porous material. A plurality of suction holes 12 are provided on the pressing surface, that is, the lower surface of the stage 11 for suction dewatering. The suction holes 12 are connected to a suction unit not shown in the figure.

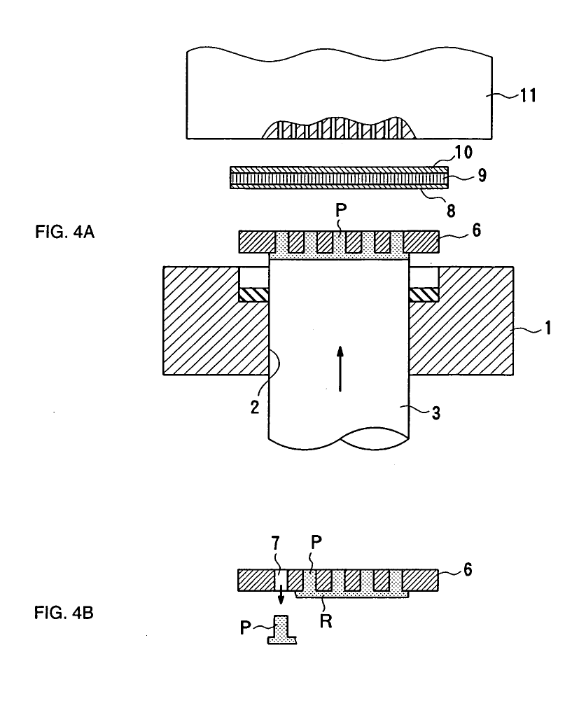

The operation of the above molding apparatus will now be described with reference to FIGS. 3A to 4B.

FIG. 3A shows an initial state. In FIG. 3A, the rubber packing 5 and the separable die plate 6 are separated from the die 1. In this state, a predetermined amount of ceramic slurry S is supplied in the cavity 2 of the die 1.

Subsequently, as shown in FIG. 3B, the rubber packing 5 and the separable die plate 6 are fitted with the die 1. The filter paper 8, the filter cloth 9, and the wire gauze 10 are sequentially disposed on the separable die plate 6. The die 1 is pressed from the top using the stage 11 for suction dewatering. In this state, wet pressing is started by pressing the punch 3 upward while suction dewatering is performed through the suction holes 12. The slurry S is pressurized by the upward movement of the punch 3, and pressed into the molding holes 7 of the separable die plate 6. At the same time, the excessive solvent is removed by filtering through the filter paper 8, the filter cloth 9, and the wire gauze 10, which are disposed at the rear of the separable die plate 6, by the stage 11 for suction dewatering.

FIG. 3C shows the state in which the wet pressing is almost completed. In this state, the punch 3 reaches a molding end point. At this end point, the punch 3 is not in contact with the separable die plate 6 and a small clearance δ is formed therebetween. The height of this clearance δ is preferably, for example, 1 mm or less. Thus, the molding is completed before the punch 3 is contacted with the separable die plate 6. Therefore, the pressure to the slurry S is evenly applied to all the molding holes 7. As a result, variation in the density between green compacts can be decreased.

FIG. 4A shows a second state. After the wet pressing is completed, the stage 11 for suction dewatering is removed upward, and in addition, the filter paper 8, the filter cloth 9, and the wire gauze 10 are removed from the die 1. In this state, the punch 3 is further pressed upward from the molding end point so that the separable die plate 6 is lifted up from the die 1 with the punch 3. Thus, the separable die plate 6 can be easily removed from the die 1.

FIG. 4B shows a state in which a green compact P is released from a molding hole 7 of the separable die plate 6, which was removed from the die 1. Since the molding hole 7 is open at the upper and lower principal surfaces of the separable die plate 6, the green compact P can be easily released from the molding hole 7 by pressing the green compact P from the upper surface side of the separable die plate 6. An excess thickness part (i.e., connecting part) R is adhered to the lower surface of the separable die plate 6 so as to connect green compacts P to each other. However, because of the very small thickness, the excess thickness part R can be readily broken. In addition, this structure does not cause part of the green compact P to be chipped when the green compact P is released from the separable die plate 6. If the resultant green compact P still includes the excess thickness part R, trimming should be appropriately performed.

Subsequently, the green compact P is dried and then sintered to produce a ceramic sintered compact. Outer electrodes and the like are formed on the sintered compact, and thus completing a ceramic electronic component.

A specific Example of the method for molding in this embodiment will now be described.

First, a ceramic powder (including BaTiO₃), purified water, and a dispersant were charged in a ball mill and wet milling was performed. Thus, slurry containing the ceramic powder was prepared. An oleophilic die lubricant was applied on the die 1 and the separable die plate 6. Subsequently, a predetermined amount of the slurry was charged in the space of the cavity 2 formed by the die 1 and the punch 3. After the slurry was charged, the separable die plate 6 was fitted in the recess 4 of the die 1. The filter paper 8, the filter cloth 9, and the wire gauze 10 were sequentially disposed on the separable die plate 6, and the stage 11 for suction dewatering was then disposed on the wire gauze 10. Subsequently, wet pressing was performed by pressing the punch 3. When the surface pressure of the punch 3 was 6 to 16 MPa, the time required for molding was 13 to 5 minutes. Green compacts P connected with a thin connecting part R was removed together with the separable die plate 6. Subsequently, cylindrical green compacts P having a diameter of 7 mm and a length of 19 mm were prepared by pressing. This molding was repeated 24 times. The green compacts P were dried and then sintered at 1,300° C. Thus, sintered compacts having high density were obtained.

According to the evaluation result of the compact density of the green compacts P, the value 3CV (=3δ/average×100), which represented the variation in the density, was 0.83%. Thus, a satisfactory result was obtained. Furthermore, since the sintered compacts in this Example had the size of the final product, a cutting operation was not necessary and the loss of material was barely generated.

The following experiment was performed as a Comparative Example to compare with the above Example.

A die (that did not include the separable die plate 6 and the recess 4) having the same shape as that of the above die 1 was used. An oleophilic die lubricant was applied on the die. Wet pressing was performed under the same conditions as those in the Example using the same slurry as that in the Example. When the surface pressure of the punch was 16 MPa, the time required for molding was 15 minutes. A block-shaped green compact having an area of 60 mm square and a thickness of 17 mm was prepared by this method. This molding was repeated 64 times to prepare 64 green compacts. According to the measurement result of the compact density, the variation represented by 3CV (=3δ/average×100) was 1.9%.

One of the sintered compacts sintered at 1,300° C. was processed by a cutting operation in order to obtain 55 cut samples (which was the same number as the number of samples per shot in the above Example) having a diameter of 5 mm. The loss of material generated by this cutting operation was 35 weight percent.

### SECOND EMBODIMENT

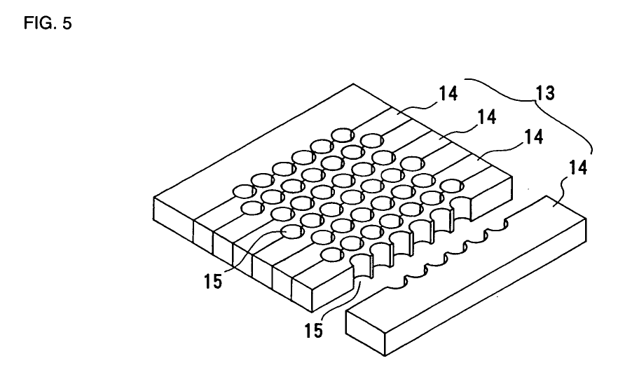

FIG. 5 shows a second embodiment of the present invention.

This embodiment is an example using a split type (i.e., segmental die type) separable die plate 13.

The separable die plate 13 is formed by combining a plurality of die members 14 adjacent to each other and separable from each other. Each molding hole 15 is defined by a pair of partial holes defined respectively in a pair of adjacent die members 14. The die members 14 are divided so as to separate molding holes 15. After the molding, the separable die plate 13 is removed from the die 1. Subsequently, green compacts P can be easily released by dividing the separable die plate 13.

### THIRD EMBODIMENT

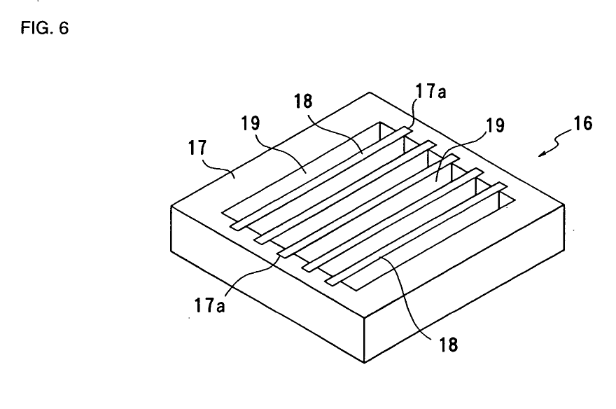

FIG. 6 shows a third embodiment of the present invention.

In this embodiment, a separable die plate 16 includes a frame 17 and at least one blade (partition plate) 18 (five blades in this example). Grooves 17a are provided on the inner faces of the frame 17. Both ends of the blades 18 are inserted in the grooves 17a to form a plurality of molding holes 19.

In this embodiment, after the molding, the separable die plate 16 is removed from the die 1. Subsequently, the blades 18 are removed from the separable die plate 16. Thus, green compacts P having a long rectangular column shape (for example, 7 mm×7 mm×120 mm) can be easily released.

When the separable die plate 13 or 16 described in the second or third embodiment, which can be divided, is used, green compacts having a large aspect ratio can be readily produced.

The ceramic in the present invention includes not only ceramics used in dielectric materials, piezoelectric materials, magnetic materials, resistors, or the like, but also glass materials mainly including crystallized glass, and cement materials.

While preferred embodiments of the invention have been described above, it is to be understood that variations and modifications will be apparent to those skilled in the art without departing the scope and spirit of the invention. The scope of the invention, therefore, is to be determined solely by the following claims.

What is claimed is:

1. A method for producing a ceramic green compact comprising the steps of:
disposing a separable die including a plurality of molding through holes in a cavity of a molding die;
supplying the cavity of the molding die with slurry containing a ceramic powder and a solvent;
forming a plurality of green compacts in the molding holes by pressurizing the slurry in the cavity by moving a punch provided in the molding die so as to press the slurry into the molding holes of the separable die, while the solvent is removed to the rear of the separable die;
removing the separable die from the molding die; and
releasing the plurality of green compacts from the molding holes of the separable die in a separate state.

2. The method for producing a ceramic green compact according to claim 1,
wherein, in the step of forming green compacts in the molding holes, a molding end point is set such that the movement of the punch is completed before the punch is in contact with the separable die, and the green compacts formed in the molding holes are connected to each other, with a connecting part therebetween having a small thickness and being formed on a surface of the separable die, the surface being adjacent to the punch, and
wherein the connecting part is removed in the step of releasing the green compacts from the molding holes of the separable die so as to place the green compacts in said separate state.

3. The method for producing a ceramic green compact according claim 1,
wherein a recess extending from the cavity is provided on a surface of the molding die, the surface being disposed at the side where the solvent is removed, and
wherein the periphery of the separable die is positioned in the recess.

4. The method for producing a ceramic green compact according to claim 1,
wherein the separable die comprises a flat mold plate, and
wherein the molding holes are formed so as to be open at both principal surfaces of the mold plate.

5. The method for producing a ceramic green compact according to claim 1, wherein the separable die comprises a plurality of flat mold plates disposed in a series in the direction parallel to both principal surfaces of the mold plates.

6. The method for producing a ceramic green compact according to claim 5, wherein said plurality of flat mold plates are mounted closely adjacent to each other in said die, and each molding hole is defined by a pair of partial holes defined respectively in a pair of adjacent mold plates.

7. The method for producing a ceramic green compact according to claim 1, wherein said separable die comprises a frame and at least one blade removably mounted in said frame, said molding holes being defined between said at least one blade and said frame.

8. The method for producing a ceramic green compact according to claim 7, wherein said at least one blade comprises a plurality of blades, spaced apart from each other in said frame to define additional molding holes.

9. The method for producing a ceramic green compact according to claim 1, wherein the inner surfaces of the molding holes of the separable die are tapered surfaces each having a slope in the thickness direction of the separable die.

10. A method for producing an electronic component comprising the steps of:
providing a ceramic green compact by the method according to claim 1; and
sintering the ceramic green compact to obtain a ceramic sintered compact.

11. An apparatus for producing a ceramic green compact comprising:
a molding die including a cavity for receiving slurry containing a ceramic powder and a solvent;
a separable die disposed in the cavity so as to be separated from the molding die, the separable die including a plurality of molding through holes;
a punch that pressurizes the slurry in the cavity so as to press the slurry into the molding holes of the separable die, thereby forming green compacts in the molding holes; and
a unit for removing the excess solvent in the slurry in the molding holes, the unit being provided at a position facing the punch.

12. The apparatus for producing a ceramic green compact according to claim 11,
wherein, at an end point of movement of the punch, a clearance having a thickness smaller than the thickness of the separable die is defined between the punch and the separable die, and
wherein said clearance allows green compacts formed in the molding holes to be connected to each other, by a connecting part therebetween having a small thickness and being formed on a surface of the separable die, the surface being adjacent to the punch.

13. The apparatus for producing a ceramic green compact according to claim 11, wherein the molding die comprises a recess for positioning the periphery of the separable die, the recess being disposed adjacent to the unit for removing the excess solvent.

14. The apparatus for producing a ceramic green compact according to claim 11,
wherein the separable die comprises a flat mold plate, and
wherein the molding holes are provided so as to be open at both principal surfaces of the mold plate.

15. The apparatus for producing a ceramic green compact according to claim 11, wherein the separable die comprises a plurality of flat mold plates disposed in a series in the direction parallel to both principal surfaces of the mold plates.

16. The apparatus for producing a ceramic green compact according to claim 15, wherein said plurality of flat mold plates are mounted closely adjacent to each other in said die, and each molding hole is defined by a pair of partial holes defined respectively in a pair of adjacent mold plates.

17. The apparatus for producing a ceramic green compact according to claim 11, wherein said separable die comprises a frame and at least one blade removably mounted in said frame, said molding holes being defined between said at least one blade and said frame.

18. The apparatus for producing a ceramic green compact accoridng to claim 17, wherein said at least one blade comprises a plurality of blades, spaced apart from each other in said frame to define additional molding holes.

19. The apparatus for producing a ceramic green compact according to claim 11, wherein the inner surfaces of the molding holes of the separable die are tapered surfaces each having a slope in the thickness direction of the separable die.
